(19) United States
(12) Patent Application Publication
(10) Pub. No.: US 2016/0254550 A1
(43) Pub. Date: Sep. 1, 2016

(54) MANUFACTURING METHOD AND MANUFACTURING APPARATUS OF GAS DIFFUSION LAYER FOR FUEL CELL

(71) Applicant: TOYOTA JIDOSHA KABUSHIKI KAISHA, Toyota-shi, Aich-ken (JP)

(72) Inventor: Yukihiro SHIBATA, Toyota-shi (JP)

(73) Assignee: TOYOTA JIDOSHA KABUSHIKI KAISHA, Toyota-shi, Aichi-ken (JP)

(21) Appl. No.: 15/027,072

(22) PCT Filed: Sep. 4, 2014
(86) PCT No.: PCT/JP2014/004559

§ 371 Date: Apr. 4, 2016

(30) Foreign Application Priority Data
Oct. 11, 2013 (JP) 2013-213796

(51) Int. Cl. H01M 4/88; B05D 3/02; B05D 1/26; B05D 1/36; H01M 8/1004; H01M 4/86

(52) U.S. Cl. CPC H01M 4/8807; H01M 8/1004; H01M 4/8626; B05D 1/265; B05D 1/36; B05D 3/0272

(57) ABSTRACT

The manufacturing method of a gas diffusion layer for fuel cell includes coating a first coating fluid for forming a microporous layer on one surface of a porous base material used for formation of a substrate layer, and coating a second coating fluid for water repellent treatment having a lower viscosity than viscosity of the first coating fluid on the other surface of the base material facing downward in a direction of gravity.

### TECHNICAL FIELD

The present application claims the priority based on Japanese Patent Application No. 2013-213796 filed on Oct. 11, 2013, the disclosure of which is hereby incorporated by reference in its entirety.

The present invention relates to a manufacturing method of a gas diffusion layer used for a gas diffusion electrode of a solid electrolyte fuel cell.

### BACKGROUND ART

A fuel cell is a device configured to generate electricity by electrochemical reaction of hydrogen as a fuel gas and oxygen as an oxidizing gas. In the description below, the fuel gas and the oxidizing may not be differentiated from each other but may be collectively called “reactive gas” or “gas”. The fuel cell generally has a stack structure in which a plurality of unit cells are stacked. One unit cell is configured to have a membrane electrode assembly (MEA) as a power generating element placed between conductive separators. The MEA is the power generating element in which gas diffusion electrodes (anode and cathode), each including a catalyst electrode layer (hereinafter also called “catalyst laver”) and a gas diffusion layer (GDL), are joined with both surfaces of a solid polymer electrolyte membrane (hereinafter also called “electrolyte layer”) having proton (H+) conductivity, The MEA is also called membrane electrode and gas diffusion layer assembly (MEGA).

The gas diffusion layer is desired to have a function of diffusing reactive gas to uniformly supply the reactive gas from a gas flow path arranged on a separator-side surface of the gas diffusion layer to the catalyst layer, a function of discharging water produced in the catalyst layer to a gas flow path, and a function of conducting electrons for the electrochemical reaction. A known structure of the gas diffusion layer having such functions has a substrate layer of porous structure and a microporous layer (hereinafter also called “MPL”) of porous structure having pores of the smaller diameter than that of the pores of the substrate layer, which is laid on the substrate layer. Known manufacturing methods of the gas diffusion layer having MPL are, for example, described in Patent Literatures 1 and 2.

### CITATION LIST

### Patent Literature

### [PTL 1]

### WO 2011/030720

### [PTL 2]

### JP 2010-267539A

### SUMMARY OF INVENTION

### Technical Problem

The manufacturing method described in Patent Literature 1 includes: coating a coating fluid for forming a conductive microparticulate layer (corresponding to MPL) on a surface of a base material which has been subject to water repellent treatment and is used for formation of a substrate material; and then making the base material with the coating of the conductive microparticulate layer (hereinafter also referred to as “MPL”) subject to heat treatment, so as to manufacture a gas diffusion layer. This manufacturing method generally has two-stage manufacturing processes (also called. “passes”), which are performed separately. The first pass coats a coating fluid for water repellent treatment (hereinafter also referred to as “water-repellent coating fluid”) on the base material and performs drying to manufacture the water-repellent base material. The second pass coats a coating fluid for forming MPL (hereinafter also referred to as “MPL coating fluid”) on the water-repellent base material and performs heat treatment to manufacture a gas diffusion layer. With regard to this 2-pass manufacturing method, there is a need to reduce the production time, reduce the number of processes and reduce the manufacturing cost, in terms of enhancing the productivity.

A possible measure of reducing the manufacturing cost by reduction of the production time or reduction of the number of processes simply omits the drying process and provides a 1-pass manufacturing method that coats the water-repellent coating fluid on the base material without performing drying and subsequently coats the MPL coating fluid on the coated surface of the base material and performs heat treatment, This may, however, cause the MPL coating fluid to soak into the base material coated with the water-repellent coating fluid. The occurrence of bleed-through of the MPL coating fluid may result in the problem of reducing water repellency and gas diffusibility of the gas diffusion. layer. This may also cause the unevenness of the viscosity in the coating film of the MPL coating fluid. This may result in the problem of deteriorating the quality of the coating film (occurrence of variation in in-plane coating weight and occurrence of variation in thickness).

The manufacturing method described in Patent Literature 2 includes: coating an MPL component material of a mixed solution (coating fluid) including at least a conductive material and a water repellent agent on one surface of a base material without water repellent treatment; performing drying with shielding the mixed solution side of the base material; and then performing firing (corresponding to heat treatment), so as to manufacture a gas diffusion layer. This method shortens the coating process of the water-repellent coating fluid and the MPL coating fluid from the 2-step process to the 1-step or 1-pass process. This method, however, needs the drying process as an essential separate process besides the firing process, like the above 2-pass manufacturing method. The time required for the separate drying process is significantly longer than the time required for the coating process. This method accordingly has only limited effect on reduction of the production time and also has insufficient enhancement of the productivity.

As described above, in terms of enhancing the productivity of the gas diffusion layer, there is a need to reduce the production time and reduce the manufacturing cost, while maintaining the quality.

### Solution to Problem

The invention may be implemented by any of the following aspects, in order to solve at least part of the above problems.

(1) A first aspect of the present invention is a manufacturing method of a gas diffusion layer for fuel cell having a substrate layer and a microporous layer. The manufacturing method includes coating a first coating fluid for forming the microporous layer on one surface of a porous base material used for formation of the substrate layer, and coating a second coating fluid for water repellent treatment having a lower viscosity than viscosity of the first coating fluid on the other surface of the base material facing downward in a direction of gravity. Since the manufacturing method according to this aspect coats the second coating fluid upward in the direction of gravity onto the surface of the base material which is opposite to the surface coated with the first coating fluid and faces downward in the direction of gravity, the second coating fluid penetrates into the base material mainly by capillarity against the gravity. This suppresses the second coating fluid from reaching the coated surface of the first coating fluid. This accordingly suppresses reduction in water repellency and reduction in gas diffusibility of the gas diffusion layer and deterioration of the quality of the coating film of the first coating fluid for forming the microporous layer caused by mixing the first coating fluid for forming the microporous layer with the second coating fluid for water repellent treatment as described in Technical Problem. This allows for omission of the separate drying process that is essential in the prior art manufacturing process and reduces the manufacturing time and the manufacturing cost.

(2) In the above manufacturing method, the step of coating the second coating fluid may be performed after the step of coating the first coating fluid. This configuration shortens the time for penetration of the second coating fluid through the base material, compared with a configuration of coating the second coating fluid for water repellent treatment prior to the first coating fluid for forming the microporous layer. This further enhances the effect of suppressing the second coating fluid for water repellent treatment from reaching the coated surface of the first coating fluid for forming the microporous layer.

(3) The above manufacturing method may further includes heat treating the base material coated with the first coating fluid and with the second coating fluid. This configuration shortens the time period between coating the second coating fluid for water repellent treatment and heating the base material. This further enhances the effect of suppressing the second coating fluid for water repellent treatment from reaching the coated surface of the first coating fluid for forming the microporous layer.

The invention may be implemented by any of various aspects other than the manufacturing method of the gas diffusion layer for fuel cell according to the above aspect. One example of such aspects is a manufacturing apparatus of a gas diffusion layer for fuel cell, which is configured to perform the manufacturing method of the gas diffusion layer of the above aspect.

### BRIEF DESCRIPTION OF DRAWINGS

FIG. 1 is a diagram illustrating a manufacturing method of a gas diffusion layer for a fuel cell according to an embodiment;

FIG. 2 is a graph showing the state of MPL coating weight of a gas diffusion layer manufactured by the manufacturing method of the embodiment, in comparison with the states of MPL coating weight of gas diffusion layers manufactured by manufacturing methods of Comparative Examples 1 and 2; and

FIG. 3 is a diagram illustrating measurement positions of MPL coating weight in the manufactured gas diffusion layers.

### DESCRIPTION OF EMBODIMENT

### A. Embodiment

### (1) Manufacturing Method of Embodiment

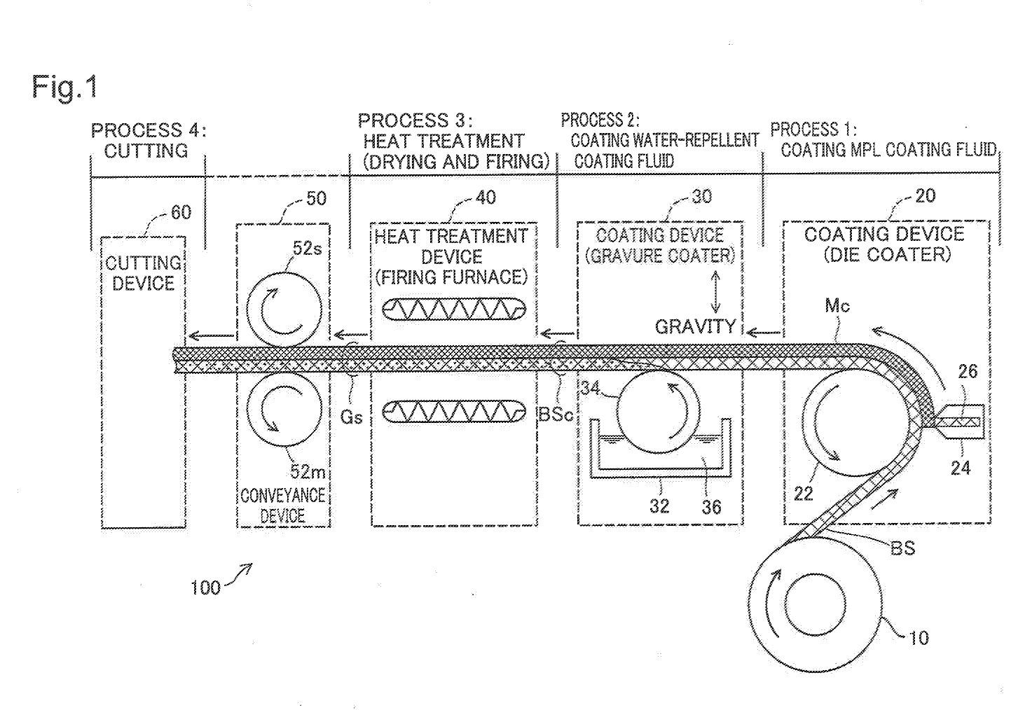

FIG. 1 is a diagram illustrating a manufacturing method of a gas diffusion layer for a fuel cell according to one embodiment. The manufacturing method of the gas diffusion layer for the fuel cell according to this embodiment is performed by a manufacturing apparatus 100 including a first coating device 20, a second coating device 30, a heat treatment device 40, a conveyance device 50 and a cutting device 60. In this manufacturing apparatus 100, a long sheet of base material BS used for formation of a substrate layer of a gas diffusion layer is wound off from a base material roll 10 by the conveyance device 50 and is sequentially fed through the first coating device 20, the second coating device 30, the heat treatment device 40 and the cutting device 60 so as to be sequentially subject to process 1, process 2, process 3 and process 4 corresponding to the respective devices. Accordingly, the first coating device 20, the second coating device 30 and the heat treatment device 40 are sequentially arranged in the middle of a conveyance path of the base material BS would off from the base material roll 10 and conveyed by the conveyance device 50. The conveyance device 50 conveys the base material BS by winding off the base material BS from the base material roll 10, in cooperation with holding and sequentially pulling in a long sheet of gas diffusion layer Gs formed in the heat treatment device 40 by means of a vertical pair of a drive conveyance roll 52m and a driven conveyance roll 52s. The base material BS may be a sheet material having electric conductivity and porosity, for example, a porous sheet material made of carbon fibers such as carbon paper, carbon cloth or carbon unwoven fabric.

### <Process 1>

The first coating device 20 for the process 1 is comprised of a die coater. The first coating device 20 includes a backup roll 22 and a die head 24 arranged to be opposed. to the backup roll 22. The die head 24 is filled with a coating fluid 26. More specifically, the die head 24 is filled with a coating fluid for formation of a microporous layer (hereinafter referred to as “MPL coating fluid”) 26 to form a microporous layer (hereinafter also referred to as “MPL”) on one surface of the base material BS. The microporous layer has a porous structure comprised of microscopic pores of smaller diameter than that of pores consisting of the porous structure of the base material BS. The location of the die head 24 is not restricted to the position illustrated in FIG. 1 but is not specifically limited as long as the die head 24 is arranged to be opposed to the backup roll 22.

In the process 1, the MPL coating fluid 26 is coated by the die head 24 on a surface of the base material BS fed from the base material roll 10, which is opposite to the surface of the base material BS in contact with the backup roll 22. The coating weight is 2 to 6 [mg/cm²]. The thickness of a coating film Mc of the MPL coating fluid 26 depends on the rate of the base material BS passing through between the die head 24 and the backup roll 22 and an ejection rate of the MPL coating fluid 26 ejected from the die head 24.

The base material BS with coating of the MPL coating fluid 26 is conveyed through the second coating device 30, such that the coated surface faces upward. in the direction of gravity and the uncoated surface faces downward.

The MPL coating fluid 26 used herein is a paste or slurry prepared by mixing and dispersing mainly a conductive material and a binder with and in a solvent. An additive such as a dispersant may be added to the MPL coating fluid 26, but it is preferable that the MPL coating fluid 26 does not contain metal, in order to avoid contamination. In the description below, the MPL coating fluid 26 is assumed as a paste prepared by mixing and dispersing a conductive material, a binder and a dispersant with and in a solvent. The conductive material used may be carbon having the mean particle size of 20 to 150 [nm], is, for example, carbon black having excellent electric conductivity and large specific surface area and is preferably acetylene black having especially high electrical conductivity The binder used may be a fluorinated polymer material such as polytetrafluoroethylene (PTFE), polyvinylidene fluoride (PVDF), polyhexafluoropropylene or tetrafluoroethylene-hexafluoropropylene copolymer, polypropylene or polyethylene. Among these materials, a fluorinated polymer material, especially PTFE is preferably used. The solvent used is not specifically limited but may be any of various solvents such as water, methanol and ethanol. A surface active agent used as the dispersant is also not specifically limited but may be any of various surface active agents including ester-based, ether based and ester-ether-based nonionic surface active agents. In this example, acetylene black is used as the carbon, and TPFE is used as the binder. The composition of the MPL coating fluid 26 is adjusted to have 70 to 90 [mass %] of carbon particles, 1.5 to 25 [mass %] of the binder and 5 to 15 [mass %] of the dispersant relative to 100 [mass %] of the total solid content of the carbon, the binder and the dispersant. The properties of the MPL coating fluid 26 are set to the solid content ratio of 15 to 25 [mass %], the viscosity of 500 to 2500 [mPa*s (50/s)] at a shear rate of 50 [s⁻¹] and the storage elastic modulus of 500 to 5500 [Pa]. The viscosity of the MPL coating fluid 26 herein is set such as to suppress the MPL coating fluid 26 from soaking into the base material BS and maintain the coating film Mc in a set thickness. The viscosity and the storage elastic modulus are measured with a viscometer.

### <Process 2>

The second coating device 30 for the process 2 is comprised of a kiss gravure coater which does not have a backup roil but includes a gravure roll 34 and a container 32 for storing a coating fluid. for water repellent treatment (hereinafter referred to as “water-repellent coating fluid”) 36 to provide the base material BS with water repellency The base material BS fed to the second coating device 30 is arranged such that the coated surface of the MPL coating fluid 26 faces upward in the direction of gravity and the uncoated surface faces downward. The gravure roll 34 is located below the base material BS in the direction of gravity to be opposed to the surface of the base material BS facing downward in the direction of gravity.

In the process 2, the water-repellent coating fluid 36 is coated by the gravure roll 34 on the surface of the base material BS, which is fed from the first coating device 20, facing downward in the direction of gravity, i.e., the surface opposite to the coating surface of the MPL coating fluid 26 in the process 1. The coating weight is 0.1 to 1 [mg/cm²].

The second coating device 30 is comprised of the kiss gravure coater without a backup roll, because of the following reason, The coating film Mc in the wet state is formed by coating the MPL coating fluid 26 in the first process on the other surface opposite to the surface on which the water-repellent coating agent 36 is to be coated. This structure suppresses the quality of the coating film Mc from being deteriorated. (occurrence of variation in in-plane coating weight and occurrence of variation in thickness) by the contact with the backup roll.

The water-repellent coating fluid 36 is a dispersion of a water repellent agent. Available examples of the water repellent agent include fluorinated polymer materials such as PTFE, polyhexafluoropropylene and tetrafluoroethylene-hexafluoropropylene copolymer, polypropylene and polyethylene. Among these materials, a fluorinated polymer material, especially PTFE is preferably used. In this example, PTFE is used as the water repellent agent, and the viscosity of the water-repellent coating fluid 36 is adjusted to 1 to 100 [mPa*s] at a shear rate of 50 [s⁻¹ ] by diluting a dispersion of PTFE with particle size of 100 to 400 [nm] to have a concentration of 3 to 5 [mass %]. The viscosity of the water-repellent coating fluid 36 is set to be lower than the viscosity of the MPL coating fluid 26 described above.

The coated water-repellent coating fluid 36 moves up from the coating surface by capillarity to penetrate into the base material BS. The water repellent agent is accordingly distributed over the surface and inside of the base material BS to achieve the water repellent treatment providing the water repellency

### <Process 3>

The heat treatment device 40 for the process 3 is comprised of a general firing furnace. While a coated base material BSc with the MPL coating fluid 26 and the water-repellent coating fluid 36 is sequentially fed from the second coating device 30, moves through the heat treatment device 40 and is fed out of the heat treatment device 40, the process 3 heats the coated base material BSc to dry the water-repellent coating fluid 36 and fire the coating film Mc of the MPL coating fluid 26. This process provides the base material BS with the water repellency by the water repellent agent included in the water-repellent coating fluid 36 and fixes the coating film Mc of the MPL coating fluid 26 as MPL on the base material BS, so as to form the long sheet of gas diffusion layer Gs in which the substrate layer and MPL are stacked.

The heating time for drying and firing (drying-firing time) in the heat treatment device 40 is equivalent to a time period when the coated base material BSc fed into the heat treatment device 40 is fed out of the heat treatment device 40. This time depends on the moving speed and the moving length of the coated base material BSc moving through the heat treatment device 40. The heating temperature (drying-firing temperature) in the heat treatment device 40 is temperature for thermally fusing the carbon particles and the binder included in the MPL coating fluid 26 and is appropriately selected to an adequate temperature according to the hinder used. For example, PTFE is used as the binder, the heating temperature is set to the temperature of, for example, 300 degree C. to 400 degree C. There is no specific upper limit of the heating temperature. The heating time (drying-firing time) is set to an adequate time, for example, about 1 minute to 120 minutes, according to, for example, the coating amount of the coating fluid and the heating temperature. There is also no specific upper limit of the heating time.

In simply taking into account the stability of the MPL structure, the heating temperature is preferably about 400 degree C. and the heating time is preferably about 120 minutes. In additionally taking into account the water repellency provided to the base material BS, the following conditions are desired.

As described above, the water-repellent coating fluid 36 coated on the base material BS moves up through the base material BS and penetrates into the base material BS by capillarity. The distribution of the water repellent agent between the lower surface of the base material BS on the lower side in the direction of gravity and the upper surface on the opposite side is thus varied according to the relationship between the rate of penetration of the water-repellent coating fluid 36 and the drying rate depending on the heating temperature and the heating time. Simply speaking, the concentration of the water repellent agent tends to increase on the lower surface side of the base material BS and decrease on the upper surface side. The lower heating temperature and the longer heating time cause the lower drying rate. This accelerates penetration of the water-repellent coating fluid 36 and increases the concentration of the water repellent agent on the upper surface side of the base material BS. The higher heating temperature and the shorter heating time, on the other hand, cause the higher drying rate. This decreases the concentration of the water repellent agent on the upper surface side of the base material BS. The distribution of the water repellent agent in the base material BS is adjustable in this manner by regulating the heating temperature and the heating time.

In the case that the water repellency provided to the base material BS is to be spread over the entire base material BS, it is preferable to set the lower heating temperature and the longer heating time. The heating temperature in this case is, however, contradictory to the heating temperature taking into account the stability of MPL. It is thus preferable to set the heating temperature and the heating time to adequate temperature and time by taking into account both formation of the MPL and distribution of the water repellent agent.

Even in the case that the water-repellent coating fluid 36 continues penetrating and reaches the coating surface of the MPL coating fluid 26, the viscosity of the. MPL coating fluid 26 is significantly higher than the viscosity of the water repellent coating fluid 36 as described above. This suppresses the water-repellent coating fluid 36 from soaking into the coating film Mc of the MPL coating fluid 26 and thereby suppresses deterioration of the quality of the MPL formed.

### <Process 4>

The cutting device 60 for the process 4 is comprised of a general cutting machine. The process 4 cuts the long sheet of gas diffusion layer Gs conveyed from the heat treatment device 40 via the conveyance device 50 into a desired shape, so as to form a gas diffusion layer in a desired shape.

### (2) Advantageous Effects

In order to check the advantageous effects of the manufacturing method. of the embodiment, the qualities of MPLs in a gas diffusion layer manufactured by the manufacturing method of the embodiment, a gas diffusion layer manufactured by a manufacturing method of Comparative Example 1. and a gas diffusion layer manufactured by a manufacturing method of Comparative Example 2 were evaluated by measuring the coating weight [mg/cm²] of the respective MPLs.

The manufacturing method of Comparative Example 1 is the 2-pass manufacturing method described in Technical Problem. Briefly speaking, the manufacturing method coated a water-repellent coating fluid on a base material in process 1 and performed drying in process 2 on the first pass to manufacture a water repellent base material. The manufacturing method then coated an MPL coating fluid on the water repellent base material in process 3, performed firing in process 4 and performs cutting in process 5 on the second pass to manufacture a gas diffusion layer.

The manufacturing method of Comparative Example 2 is the 1-pass manufacturing method as described in Technical Problem. Briefly speaking, the manufacturing method coated a water-repellent coating fluid on one surface of a base material in process 1, subsequently coated an MPL coating fluid on the coated surface in process 2, performed firing in process 3 and performed cutting in process 4 to manufacture a gas diffusion layer.

The MPL coating fluid and the water-repellent coating fluid used in both the manufacturing method of Comparative Example 1. and the manufacturing method of Comparative Example 2 was the same as the coating fluids used in the manufacturing method of the embodiment. Acetylene black having the mean particle size of 35 [nm] was used as the conductive material of the MPL coating fluid, and PTFE was used as the binder. The composition of the MPL coating fluid had 80 [mass %] of the carbon particles, 15 [mass %] of the binder and 5 [mass %] of the dispersant relative to 100 [mass %] of the total solid content of the carbon, the binder and the dispersant. The properties of the MPL coating fluid were, the solid content ratio of 20 [mass %], the viscosity of 1500 [mPa*s (50/s)] at the shear rate of 50 [s⁻¹] and the storage elastic modulus of 3000 [Pa]. The water-repellent coating fluid was a dispersion of PTFE with particle size: 200 to 300 [nm] diluted to the concentration of 4 [mass %] and had the viscosity of 50 [mPa*s] at the shear rate of 50 [s¹].

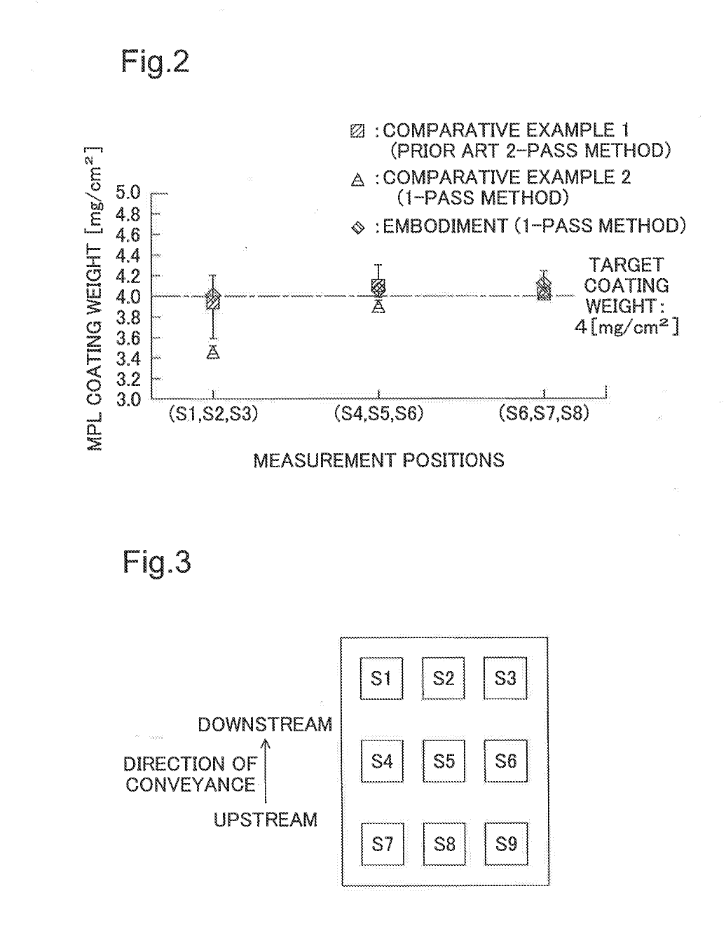

FIG. 2 is a graph showing the MPL coating weight of the gas diffusion layer manufactured by the manufacturing method of the embodiment, in comparison with the MPL coating weight of the gas diffusion layers manufactured by the manufacturing methods of Comparative Examples 1 and 2. The following describes the measurement positions of the MPL coating weight.

FIG. 3 is a diagram illustrating measurement positions of MPL coating weight in the manufactured gas diffusion layer cut-sheets. As shown in FIG. 3, specified parts of each manufactured gas diffusion layer cut-sheet were cut out, and the MPL coating weight was measured with regard to the cutout parts. More specifically, the gas diffusion layer cut-sheet was divided into three blocks, a downstream block, a mid-stream block, and an upstream block, along the direction of conveyance for cutting of the cut-sheet from downstream side to upstream side. Specified parts were then cut out of each block at three positions in a center area and respective end areas along a direction perpendicular to the direction of conveyance (S1 to S3 in the downstream block, S4 to S6 in the mid-stream block, and S7 to S9 in the upstream block), and the MPL coating weight was measured for each cutout part.

As shown in FIG. 2, relative to a target coating weight of 4 [mg/cm²], the gas diffusion layer manufactured by the prior art 2-pass method of Comparative Example 1 had the coating weight in the range of 3.9 to 4.1 [mg/cm²] at all of the measurement positions S1 to S3 in the downstream block, the measurement positions S4 to S6 in the mid-stream block and the measurement positions S7 to S9 in the upstream block. The gas diffusion. layer manufactured by the 1-pass method of Comparative Example 2 had the coating weight in the range of 3.9 to 4.1 [mg/cm²] at the measurement positions S4 to S6 in the mid-stream block and the measurement positions S7 to S9 in the upstream block like Comparative Example 1 but had the lower coating weight of not higher than 3.5 [mg/cm²] indicating the result of low stability at the measurement positions S1 to S3 in the downstream. block. The gas diffusion layer manufactured by the 1-pass method of the embodiment, on the other hand, had the coating weight in the range of 3.9 to 4.1 [mg/cm²] at all of the measurement positions S1 to S3 in the downstream block, the measurement positions S4 to S6 in the mid-stream block and the measurement positions S7 to S9 in the upstream block. This indicates the stability equivalent to that of the prior art 2-pass method of Comparative Example 1.

The manufacturing method of the embodiment coats the MPL coating fluid on one surface of the base material without performing drying, and subsequently coats the water-repellent coating fluid having the lower viscosity than that of the MPL coating fluid on the other surface and performs firing. This method reduces the production time required for the drying process and does not need the device for the drying process, thus decreasing the manufacturing cost.

The manufacturing method of the embodiment coats the water-repellent coating fluid on the other surface opposite to the one surface coated with the MPL coating fluid, while keeping the other surface face downward in the direction of gravity, and provides the base material with water repellency by taking advantage of penetration of the water-repellent coating fluid into the base material by capillarity. Accordingly, regulating the amount of such penetration controls the state of distribution of the water repellent agent in the base material and suppresses the water-repellent coating fluid from reaching the coated surface of the MPL coating fluid and entering into the coating film of the MPL coating fluid. This suppresses reduction in water repellency and reduction in gas diffusibility of the gas diffusion layer and suppresses the unevenness of the viscosity in the coating film of the MPL coating fluid, thus suppressing deterioration of the quality of the MPL.

The manufacturing method of the embodiment coats the water-repellent coating fluid with the second coating device in the process 2 at the downstream position in the direction of conveyance of the base material relative to the position where the MPL coating fluid is coated with the first coating device in the process 1. This reduces the penetration time of the water-repellent coating fluid. Accordingly, this controls penetration of the water-repellent coating fluid through the base material and suppresses the water-repellent coating fluid from reaching the coated surface of the MPL coating fluid and entering into the coating film of the MPL coating fluid. This suppresses reduction in water repellency and reduction in gas diffusibility of the gas diffusion layer and suppresses the unevenness of the viscosity in the coating film of the MPL coating fluid, thus suppressing deterioration of the quality of the MPL.

The MPL coating fluid is generally the paste-like form and has high viscosity. The water-repellent coating fluid, however, has viscosity set to be significantly lower than the viscosity of the MPL coating fluid, in order to allow for penetration by capillarity. Even when the water-repellent coating fluid reaches the coated surface of the MPL coating fluid, this arrangement suppresses the water-repellent coating fluid from entering into the coating film of the MPL coating fluid. This also suppresses reduction in water repellency and reduction in gas diffusibility of the gas diffusion layer and suppresses the unevenness of the viscosity in the coating film of the MPL coating fluid, thus suppressing deterioration of the quality of the MPL.

As described above, the manufacturing method of the embodiment reduces the production time by omitting the separate drying process besides the firing process, while maintaining the quality. This reduces the manufacturing cost and enhances the productivity of the gas diffusion layer for fuel cell.

### B. Modifications

The above embodiment describes the die coater as the example of the first coating device. The first coating device is, however, not limited to the die coater but may be any of various coating devices, such as a lip coater or a doctor coater.

The above embodiment describes the kiss gravure coater as the example of the second coating device. The second coating device may be alternatively a spray coating device. The second coating device may have any mechanism that does not have a backup roll or the like in contact with the coating film of the MPL coating fluid and enables the surface of the base material facing downward in the direction of gravity to be coated with the water-repellent coating fluid.

The above embodiment describes the configuration of coating the water-repellent coating fluid with the second coating device in the process 2 at the downstream position in the direction of conveyance of the base material relative to the position where the MPL coating fluid is coated with the first coating device in the process 1. This configuration may be modified to coat the water-repellent coating fluid on the other surface of the base material, simultaneously with mating the MPL coating fluid on one surface of the base material.

The invention is not limited to the above embodiments, examples or modifications, but a diversity of variations and modifications may be made to the embodiments without departing from the scope of the invention. For example, the technical features of the embodiments, examples or modifications corresponding to the technical features of the respective aspects described in Summary may be replaced or combined appropriately, in order to solve part or all of the problems described above or in order to achieve part or all of the advantageous effects described above. Any of the technical features may be omitted appropriately unless the technical feature is described as essential herein.

What is claimed is:

1. A manufacturing method of a gas diffusion layer for fuel cell having a substrate layer and a microporous layer, the manufacturing method comprising:
coating a first coating fluid for forming the microporous layer on one surface of a porous base material used for formation of the substrate layer, and coating a second coating fluid for water repellent treatment having a lower viscosity than viscosity of the first coating fluid on the other surface of the base material facing downward in a direction of gravity.

2. The manufacturing method according to claim 1, wherein the step of coating the second coating fluid is performed after the step of coating the first coating fluid.

3. The manufacturing method. according to claim 2, further comprising:
heat treating the base material coated with the first coating fluid and with the second coating fluid.

4. A manufacturing apparatus of a gas diffusion layer for fuel cell having a substrate layer and a microporous layer, the manufacturing apparatus comprising:
a conveyor configured to convey a base material used for formation of the substrate layer;
a first coater configured to coat a first coating fluid for forming the microporous layer on one surface of the base material; and
a second coater configured to coat a second coating fluid for water repellent treatment having a lower viscosity than viscosity of the first coating fluid on the other surface of the base material facing downward. in a direction of gravity.

5. The manufacturing apparatus according to claim 4, further comprising:
a heat treatment device for heat treating the base material coated with the first coating fluid and with the second coating fluid.
